(19) United States
(12) Patent Application Publication
(10) Pub. No.: US 2021/0016152 A1
(43) Pub. Date: Jan. 21, 2021

(54) MOUTHGUARD EMBOSSED DESIGN FEATURE AND METHOD OF MAKING

(71) Applicant: Swagguard LLC, Detroit, MI (US)

(72) Inventor: Jamarko Simmons, Pontiac, MI (US)

(73) Assignee: Swagguard LLC, Detroit, MI (US)

(21) Appl. No.: 16/517,168

(22) Filed: Jul. 19, 2019

(51) Int. Cl. A63B 71/08

(52) U.S. Cl. CPC A63B 71/085; A63B 2071/088; A63B 2071/086

(57) ABSTRACT

A device worn by a user which protects the user's teeth while the user is engaged in physical activities having design elements and features. This invention includes a mouthguard, formed of a material having a color. The mouthguard is comprised of a U-shaped body and an embossed or extruded design feature extending from a surface of the mouthguard, the design feature and the U-shaped body form a single, monolithic structure. The design feature may be the same color as the mouthguard, or it may be of a different color. The design feature may be a graphic, a text, symbol, shape, logo or any other design. It may also be a combination of graphics, text, symbols, shapes, logos, and other designs.

### TECHNICAL FIELD

The present invention is directed to design elements and features of devices which protect teeth while the user is engaged in physical activities.

### BACKGROUND OF THE ART

Conventionally, in a contact sport such as football, basketball, hockey or the like, or in other athletic and physical activities, participants may have their teeth jarred, causing injuries such as fracture of jaw bone, a laceration of soft tissue of the oral cavity, or the like, or concussions from jarring teeth. Accordingly, in order to prevent such an accident, it is desired to put a mouthpiece in the mouth of a participant.

One of the most sensitive parts of a person's body are the person's teeth. There frequently are violent collisions between persons engaged in the game of football, as an example, such as a running back being tackled by a defensive player or a wide receiver being hit by a defensive player. During these collisions, it is very easy for one or more teeth to be knocked out or otherwise damaged such as being chipped or cracked. To help protect teeth and reduce the occurrence of damage to teeth, devices such as mouthguards have been developed.

In the art, one type of mouthguard is a dental tray which is conformed to the shape of a person's upper teeth and is worn in the mouth to protect the upper teeth. In use, the mouthguard rests against the person's lower teeth to also protect the person's lower teeth. Many mouthguards are separate pieces which are taken out of the person's mouth after a play is run and either carried in the person's hand or pressed into a portion of the helmet worn by the person and is then reinserted into the mouth immediately prior to the beginning of the next play. Other types of mouthguards are attached via a strap or tether to athletic equipment such as a helmet, as is the case in the game of football.

In general, there are many devices which are used to protect a user engaged in a physical or sporting activity. In a sporting activity such as football, the user wears many protective devices to protect various body parts such as shoulder pads, leg guards, and a helmet which has bars in front to protect the user's face during physical contact while playing football. These devices are used to protect users engaged in the physical activity may be personalized with names, images, designs, or other art.

A number of mouthguards currently exist for protecting the teeth and are used for reducing the chance of shock, concussions and other injuries as a result of high impact collisions and blows during athletic competition or physical activity. Mouthguards generally are characterized as being nonpersonalized, universal and stock model type; “boil and bite”; and custom thermoformed to have upper jaw and teeth direct contact. Additionally, mouthguards may be tethered or untethered. Tethered mouthguards are usually connected to a fastening point, such as a helmet or face guard, to prevent the chance of the mouthguard from being lost as well as to prevent swallowing of the mouthguard or choking on the mouth-guard by the user. These tethers may be removable or detachable either by manual manipulation of the tether or strap or by quick-detach methods known in the art.

A number of mouthguards currently exist which are personalized to have decorative features that are added to the mouthguard and are removable. Decorative features may be applied as a sticker to the completed or partially completed mouthguards. Decorative features may be applied as a snap-on or snap-in element applied to complete or partially completed mouthguards.

Other mouthguards are personalized having concave or debossed features.

Existing mouthguards may have a breathing channel. The breathing channel may extend between an inner portion and an outer portion of the mouthguard to define an air passage allowing the user to breathe through the mouthguard via the breathing channel. The breathing channel can occupy a space in a front surface of the mouthguard.

Existing mouthguards may have a lip-guard, the lip-guard being spaced from the dental tray and contacting an outer portion of the user's lips.

A number of patents and or publications disclose custom molded mouthguards. Examples of patents and or publications that disclose fabrication of custom molded mouthguards include U.S. Pat. No. 7,882,839 that issued on Feb. 8, 2011 to Edward J. Ambis Jr. that improves the ability of the wearer to speak.

U.S. Pat. No. 6,837,246 issued on Jan. 4, 2005 to Anthony G. DeLike discloses a mouthguard with an improved tongue airway passage to improve the ability of the user to breath. The construction of this device is fabricated from a casting of the wearer's oral cavity.

U.S. Pat. No. 6,691,710 issued on Feb. 17, 2004 to Jon D. Kittelsen et al for a composite mouthguard. The composite mouthguard is constructed from multiple, mechanically interlocking pieces. Because some of the composite materials are rigid the mouthguards are made in a variety of sizes to fit different users. The fit is not custom made to users.

U.S. Pat. No. 5,879,155 issued on Mar. 9, 1999 to Jon D. Kittelsen discloses an Adjustable Customized Composite Dental Appliance With Wire Band. The wire band connects two separate posterior pads. The wire band simply maintains the position of the two separate posterior pads to prevent the pads from being swallowed. The wire band is not covered and does not provide structural support to the dental appliance.

U.S. Pat. No. US 2018/0353838 A1 discloses a sticker on a mouthguard. Marketing and advertising indicia, such as trademarks and logos, are applied on a lip-guard of the mouthguard. The marketing and advertising indicia are not an integral portion of the mouthguard.

U.S. Pat. No. 6,584,978 B1 discloses a mouthguard having a thermos form over an indicia design, where the indicia is laminated between layers of mouthguard material. Mouthguards contemplated by this invention require a transparent material to be applied over an indicia design, for a clear view.

### BRIEF DESCRIPTION OF THE DRAWINGS

FIG. 1 is a perspective view of a mouthguard having a design feature, a front wall, an inner wall, and a biting surface.

FIG. 2 is side perspective view of a mouthguard having a design feature, a front wall, an inner wall, and a biting surface.

FIG. 3 is top view of a mouthguard having a design feature, a front wall, an inner wall, and a biting surface.

FIG. 4 is a top view of a mouthguard having a design feature, a front wall, an intermediate wall, an inner wall, and a biting surface.

FIG. 5 is a perspective view of a mouthguard having a design feature, an intermediate wall, an inner wall, an elongated element, and a biting surface, said biting surface being comprised of at least one of different color and different material from the rest of the mouthguard.

FIG. 6 is a perspective view of a mouthguard having a biting surface, an intermediate wall, an inner wall, and a design feature, said design feature having at least one of a decorative element and is comprised partial of a different color or different material.

FIG. 7 is a top view of a mouthguard having a design feature, an intermediate wall, an inner wall, an elongated element, and a biting surface.

FIG. 8 is a top view of a mouthguard having a design feature, a front wall, an intermediate wall, an inner wall, an elongated element, and a biting surface.

### DETAILED DESCRIPTION

With reference to the Figures, wherein like numerals indicate like parts throughout the several views, One embodiment of a mouthguard 9 is comprised of a material having a color, having a body that is generally U-shaped, and is customizable to a variety of different sizes to fit a variety of users. The mouthguard 9 of this embodiment also has a design feature forming a monolithic structure 4 with the U-shaped body and extending inextricably from a surface of the mouthguard 9. The design feature 4 is contemplated to depict at least one of a group consisting of a graphic, a text, a symbol, a shape, and a logo.

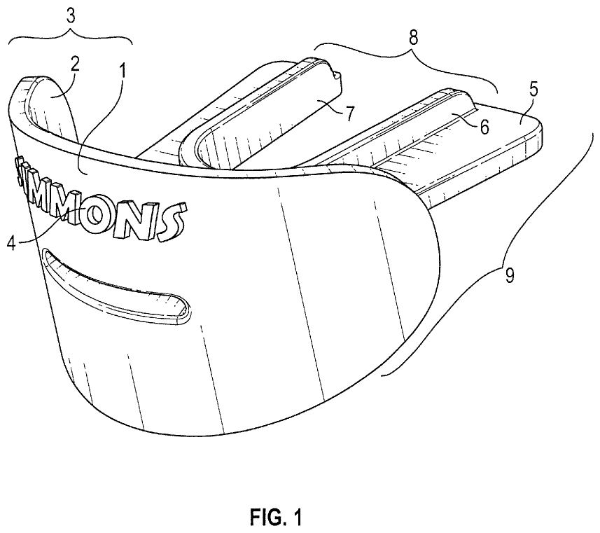

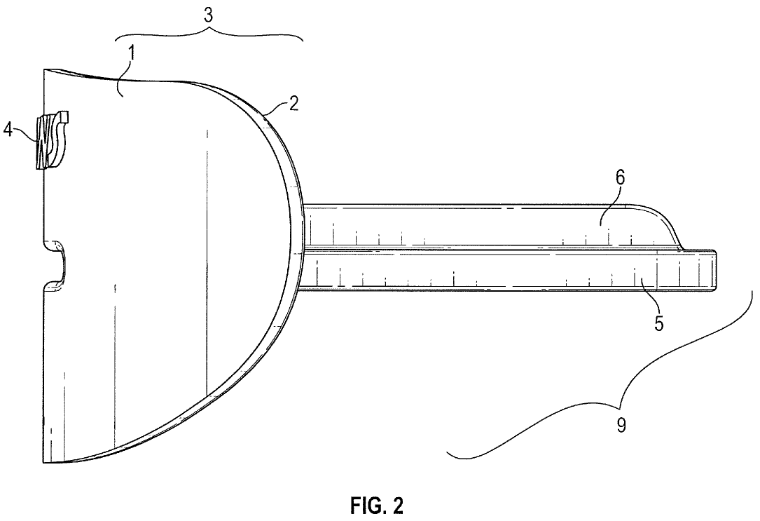

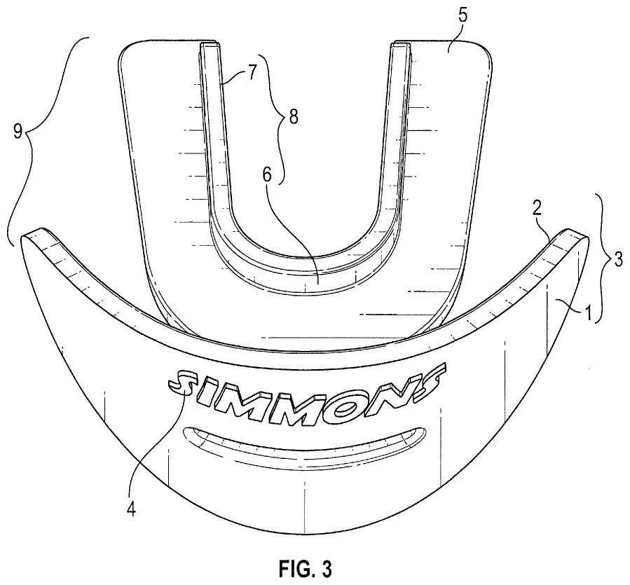

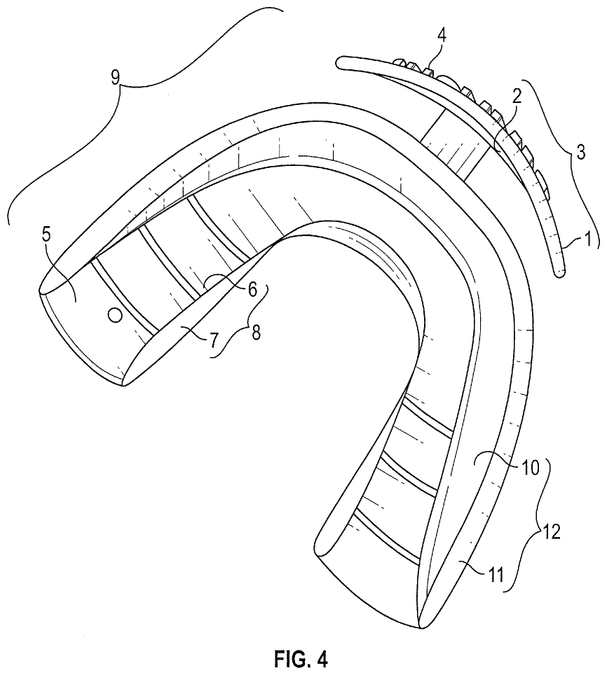

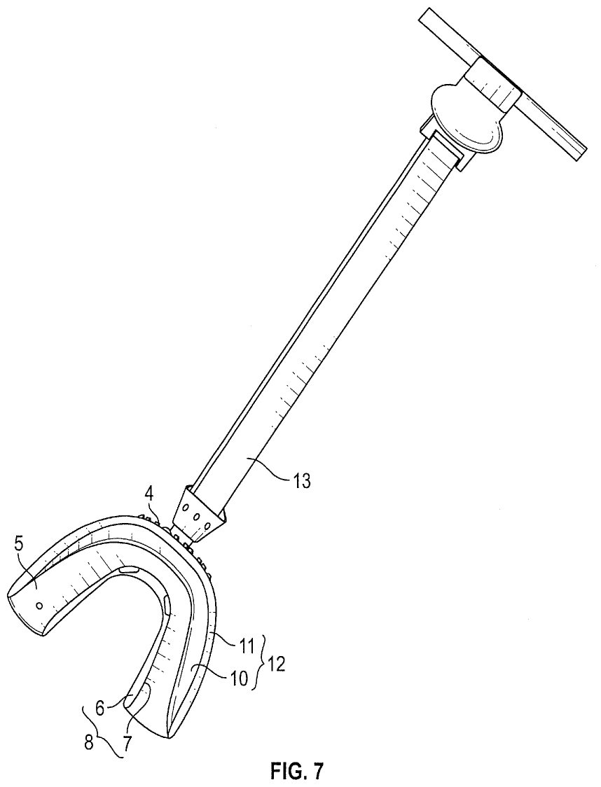

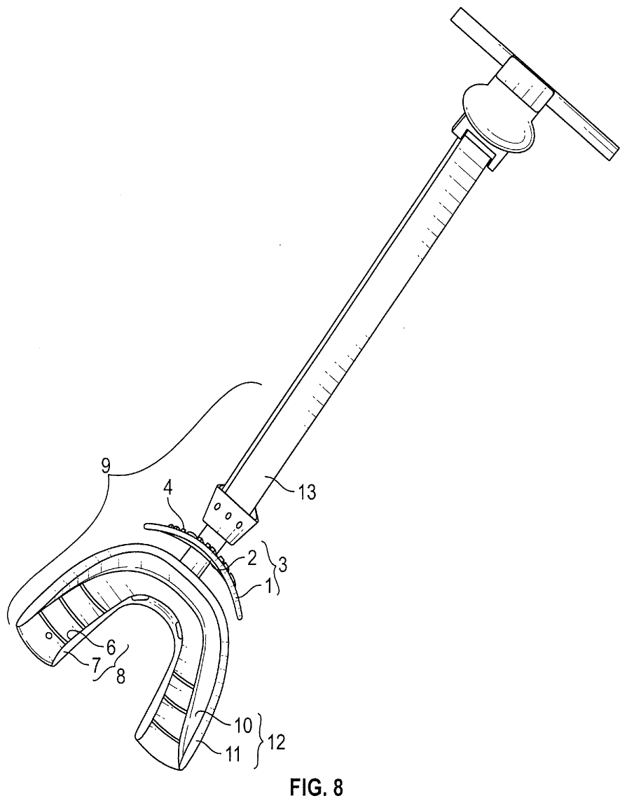

Referring to FIGS. 1-8, a mouthguard having a design feature forming a monolithic structure with a U-shaped body of the mouthguard and extending inextricably from a surface of the mouthguard, may be generally seen.

An embodiment of a mouthguard 9 may further have a front wall 3 having a back surface 2 and a front surface 1. Said back surface 2 is configured to contact at least one of an outer upper lip and outer lower lip of a user. The front surface 1 is configured to not contact the user directly. The back surface 2 and front surface 1 together form the front wall 3 which is configured to be positioned outside the mouth of the user and to contact one of the outer lips of the user. When configured in conjunction with an intermediate wall 12 the front wall 3 is contemplated to be spaced from the intermediate wall 12.

Another embodiment of a mouthguard 9 may further have a biting surface 5 which is configured to contact at least one of a user's upper teeth and lower teeth.

Another embodiment of a mouthguard 9 may further have an inner wall 8 having an outer surface 6 and an inner surface 7. Said outer surface 7 is configured to contact a tongue a user. The inner surface 6 is configured to contact a tooth or gum of the user. The outer surface 7 and inner surface 6 together form the inner wall 8 which is configured to be positioned between at least one of a tooth and gum, and the tongue of the user.

The U-shaped body can include an intermediate wall 12 having a second outer surface 11 and a second inner surface 10. Said second outer surface 11 is configured to contact at least one of an inner upper lip or inner lower lip of a user. The second inner surface 10 is configured to contact a tooth or gum of the user. The second outer surface 11 and second inner surface 10 form the intermediate wall 12 which is configured to be positioned between at least one of a tooth or gum and a lip of the user. The intermediate wall 12 is contemplated to be configured between the front wall 3 and the inner wall 8 of the mouthguard 9 of this embodiment. The intermediate wall 12 is contemplated to be spaced from the inner wall 8 and front wall 3.

Another embodiment of a mouthguard 9 may further have an elongated element 13 having a first side with means for attaching to an apparatus other than the mouthguard 9, such as clipping, tying, clamping, or looping. The elongated element 13 may also have a second side with means for attaching to the mouthguard 9 of this embodiment, such as forming a monolithic structure which is inextricably fixed, clipping, tying, clamping, or looping.

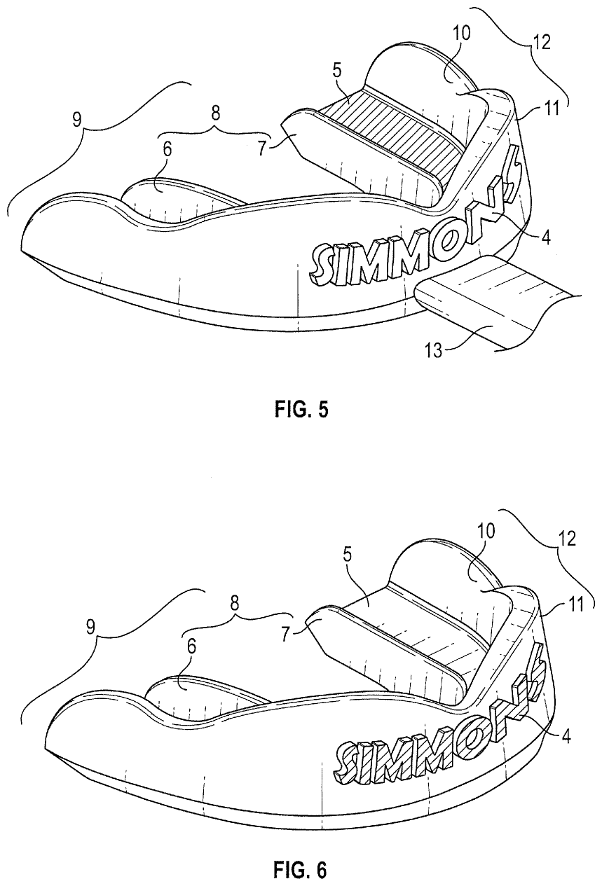

Another embodiment of a mouthguard 9 may further be comprised of a second color. FIGS. 5 & 6 show sections of two embodiments of a mouthguard which may be comprised of different colors, signified by the crosshatching in each figure.

Another embodiment of a mouthguard 9 may further be comprised of a second material. FIGS. 5 & 6 show sections of two embodiments of a mouthguard which may be comprised of different materials, signified by the crosshatching in each figure.

Another embodiment of a mouthguard 9 may further have a decorative element applied to an end region of a design feature 4. The decorative element may be painted, of a sticker form, dipped, coated, machined, or otherwise decorated as known in the art of decorating. The end region may be the surface of the design feature 4 that is furthest from surface from which the design feature extends from or is extruded from. FIG. 6 shows an embodiment of a mouthguard having a decorative element applied to an end region of a design feature.

Another embodiment of a mouthguard 9 may further have an embossed design feature 4 of the invention which is manufactured substantially concurrently with the mouthguard 9 of this embodiment. Substantially concurrently, in the art, means substantially at the same time or in immediately prior or subsequent steps as the mouthguard 9 of this embodiment.

Another embodiment of a mouthguard 9 may further have embossed design feature 4 of the invention which is manufactured at a substantially different time than the mouthguard 9 of this embodiment and is later inextricably connected or attached to the mouthguard of this embodiment. Such inextricable connection may be made before curing or cooling of the design feature 4 or the mouthguard 9 of this embodiment. Inextricable connecting may occur after curing or cooling of the design feature 4 or the mouthguard 9 of this embodiment following reheating of at least one of the design feature or the mouthguard 9 of this embodiment.

Another embodiment of a mouthguard 9 may further have a U-shaped body with a thickness between 3 mm and 10 mm as formed. One embodiment of the mouthguard 9 of this invention contemplates the U-shaped body having a thickness of substantially 5 mm as formed.

Another embodiment of a mouthguard 9 may further have a U-shaped body which is between 40 mm and 100 mm wide, 40 mm and 100 mm long, and 5 mm and 50 mm tall as formed. One embodiment of the mouthguard 9 of this invention contemplates the U-shaped body that is substantially 50 mm wide, 65 mm long, and 8 mm tall as formed.

Another embodiment of a mouthguard 9 may further have a design feature 4 which extends between 1 mm and 10 mm from a surface of the mouthguard 9 of this embodiment as formed. One embodiment of the mouthguard 9 of this invention contemplates a design feature 4 which extends substantially 5 mm from a surface of the mouthguard 9 of this embodiment as formed.

Another embodiment of a mouthguard 9 may further have a front wall 3 which is between 35 mm and 55 mm tall and 50 mm and 90 mm wide as formed. One embodiment of a mouthguard 9 of this invention contemplates a front wall 3 which is substantially 43 mm tall and 75 mm wide as formed.

In one embodiment of a mouthguard 9 a design feature 4 may extend from the front surface 1 of the front wall 3.

In one embodiment of a mouthguard 9 a design feature 4 may extend from an outer surface 11 of the intermediate wall 12.

Formation of a mouthguard 9 having a design feature 4 may occur in multiple steps. The design feature 4 may be formed substantially simultaneously with the rest of the mouthguard 9 or it may be formed in a first step where the rest of the mouthguard 9 is formed in subsequent steps. Alternatively, the mouthguard 9 may be formed in a first step and the design feature 4 may be formed in at least one subsequent step.

One embodiment of a mouthguard 9 is comprised of a material having a color, a body that is generally U-shaped and is customizable to a variety of different sizes to fit a variety of users. The U-shaped body may have a biting surface 5, said biting surface 5 configured to contact at least one upper tooth or lower tooth of the user. The embodiment also has a front wall 3 having a back surface 2 which is configured to contact the outer upper lip or outer lower lip of the user, and a front surface 1 which is configured to not contact any part of the user. The back surface 2 and front surface 1 together form the front wall 3 which is configured to be positioned outside the mouth of the user and to contact one of the outer lips of the user. The mouthguard 9 of this embodiment also has an embossed or extruded a design feature forming a monolithic structure 4 with the front wall 3 and extending inextricably from a surface of the front wall 3. Said design feature 4 depicts at least one of a group consisting of a graphic, a text, a symbol, a shape, and a logo.

The three different types of materials may be used to manufacture mouthguards. These are EVA (ethylene vinyl acetate), Polyshok and ProForm. Mouthguards have traditionally been formed of these plastics or rubbers because they engage a user's lips and upper and lower teeth to keep a mouthguard in position.

Other plastics may also be used. For example, the materials can be plastics such as polyethylene, polypropylene, acetal, acrylic, nylon (polyamides), polystyrene, polyvinyl chloride, acrylonitrile butadiene styrene, polycarbonate, thermoplastic polyesters and cellulosic resins, among others, alone and in combination with other plastics.

Other materials may be used. For example, the materials can include elastomers (e.g. rubber), cellulose microfibrils, silicon, coloring agents, and fillers.

The materials can be selected based on desired properties of the materials. The desired materials are in a raw form, and/or in a molten form, and/or as the final mouthguard.

Mouthguards may be formed by injection molding, pouring, or by thermoforming. Other methods of forming mouthguards exist in the art.

For an injection molded mouthguard, a cavity is needed, which is in a shape complementary of the mouthguard of this embodiment. Material is then heated into a fluid form and injected into the cavity or cavities taking the shape of the mouthguard of this embodiment. The cavity may be generic, having a shape of a tooth canal of certain dimension, or may be created by a unique cast of a user's oral cavity.

For a poured mouthguard, a cavity is also needed, the cavity having a complementary shape of the mouthguard of this embodiment. Material is heated into a fluid form and poured into the cavity or cavities taking the shape of the mouthguard of this embodiment.

For a thermoformed mouthguard, a mouthguard mold may be created by casting a unique cast of a user's oral cavity. A mold may also be created as a generic tooth canal of certain dimension. A material is then heated, taking a moldable form, and applied over the mold. The material cools and maintains the shape of the mold.

In one example, the material in the raw form includes an additional constituent which may have a first color. Other constituents can be added to the material such that the material has a second color different from the first color.

As used herein, the term “color” includes no color, e.g., a mouthguard in which a material is transparent. In that example, one material may be visible through one of the other materials.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1) A mouthguard comprising:
a. a generally U-shaped body;
b. said U-shaped body including a biting surface, said biting surface configured to contact at least one of the upper teeth and lower teeth of a user;
c. a design feature and the U-shaped body forming a monolithic structure with the design feature extending inextricably from a surface of the mouthguard, the design feature depicting at least one of a group consisting of a graphic, a text, a symbol, a shape, and a logo.

2) The mouthguard according to claim 1, the mouthguard further comprising:
a. a back surface, said back surface configured to contact at least one of the outer upper lip or outer lower lip of a user;
b. a front surface, said front surface configured to not contact any part of the user;
c. said back surface and front surface together forming a front wall, said front wall configured to be positioned outside a mouth of the user and to contact one of the outer lips of the user.

3) The mouthguard according to claim 1, the mouthguard further comprising:
a. an outer surface, said outer surface configured to contact the tongue of the user;
b. an inner surface, said inner surface configured to contact a tooth or gum of the user;
c. said outer surface and inner surface together forming an inner wall, said inner wall configured to be positioned between at least one of the tongue of the user and at least one of a tooth and gum.

4) The mouthguard according to claim 1, the U-shaped body further comprising:
a. a second outer surface, said second outer surface configured to contact at least one of the inner upper lip or inner lower lip of a user;
b. a second inner surface, said second inner surface configured to contact a tooth or gum of the user;
c. said second outer surface and second inner surface together forming an intermediate wall, said intermediate wall configured to be positioned between at least one of a tooth or gum and a lip of the user;

5) The mouthguard according to claim 1, said mouthguard further comprising an elongated element having a first side with means for attaching to an apparatus other than the mouthguard and having a second side with means for attaching to the mouthguard.

6) The mouthguard according to claim 1, said mouthguard assembly comprising a second color.

7) The mouthguard according to claim 1, said mouthguard assembly further comprised of a second material.

8) The mouthguard according to claim 1, further comprising a decorative element applied to the end region of said at least one embossed feature.

9) The mouthguard according to claim 1, in which the embossed feature of the invention is manufactured substantially concurrently with the rest of the mouthguard.

10) The mouthguard according to claim 1, in which the embossed feature of the invention is manufactured at a different time than the rest of the mouthguard and is subsequently inextricably connected to the rest of the mouthguard.

11) A mouthguard according to claim 1, where the U-shaped body has a thickness between 3 mm and 10 mm as formed.

12) A mouthguard according to claim 1, where the U-shaped body has a thickness of substantially 5 mm as formed.

13) A mouthguard according to claim 1, where the U-shaped body is between 40 mm and 100 mm wide, 40 mm and 100 mm long, and 5 mm and 50 mm tall as formed.

14) A mouthguard according to claim 1, where the U-shaped body is substantially 50 mm wide, 65 mm long, and 8 mm tall as formed.

15) A mouthguard according to claim 1, where the design feature extends between 1 mm and 10 mm from a surface of the mouthguard as formed.

16) A mouthguard according to claim 1, where the design feature extends substantially 5 mm from a surface of the mouthguard as formed.

17) A mouthguard according to claim 2, where the front wall is between 35 mm and 55 mm tall and 50 mm and 90 mm wide as formed.

18) A mouthguard according to claim 2, where the front wall is substantially 43 mm tall and 75 mm wide as formed.

19) A mouthguard according to claim 2, where the design feature extends from the front surface of the outer wall.

20) A mouthguard according to claim 4, where the design feature extends from the second outer surface of the intermediate wall.
